(19) United States
(12) Patent Application Publication
(10) Pub. No.: US 2008/0122203 A1
(43) Pub. Date: May 29, 2008

(54) Airbag assembly

(75) Inventors: Mark Andrew Steinbach, Clawson, MI (US); Michael Gabriel Khouri, Birmingham, MI (US)

Correspondence Address: FOLEY AND LARDNER LLP;SUITE 500, 3000 K STREET NW, WASHINGTON, DC, 20007, US

(73) Assignee: TK Holdings Inc.

(21) Appl. No.: 11/976,736

(22) Filed: Oct. 26, 2007

Related U.S. Application Data
(60) Provisional application No. 60/854,727, filed on Oct. 27, 2006.

(51) Int. Cl. B60R 21/16

(52) U.S. Cl. 280/728.2

(57) ABSTRACT

The disclosed airbag assembly is for use in a vehicle. The airbag assembly may comprise an airbag and a carrier mechanism. The airbag may comprise an inflatable cushion for protecting a vehicle occupant. The carrier mechanism may be attached to the airbag for fastening the airbag to the vehicle.

This application claims priority from U.S. Provisional Application 60/854,727, filed Oct. 27, 2006, incorporated herein by reference in its entirety.

### BACKGROUND

The present disclosure relates generally to the field of airbag assemblies. More specifically, the present disclosure relates to curtain airbag carrier mechanisms.

Generally, conventional airbag technology for curtain airbags generally uses individual fabric tabs to secure the airbag assembly along a vehicle's roof rail sheet metal. Each individual fabric tab requires its own mechanical fastener, such as a screw, pushpin, or other snap-in fastener. Typically, conventional curtain airbag installations require approximately 8 to 13 fasteners; the number of fasteners depending on the length of the curtain airbag assembly.

Conventional head side airbags have flexible cushions with an energetic source (inflator) mounted either near the middle of the airbag cushion, or at one end of the cushion. The conventional airbag system can be too flexible (floppy) and, thus, difficult to handle during initial assembly, shipping and final assembly into a vehicle.

Some conventional head side (curtain) airbags include metal tubes attached to the inflator that extend the length of the airbag cushion. These conventional airbags systems can be attached to a vehicle by multiple, flexible connections. For example, typical systems use threaded fasteners (sometimes two to three fasteners) to secure the inflator to the vehicle and also use multiple (sometimes six to ten) flexible attachment points to secure the airbag system to the vehicle roof rail.

Therefore, there is a need for an airbag assembly that modularizes the airbag assembly with the inclusion of a carrier mechanism from which the curtain is hung. The carrier member can then be a supporting member which ultimately is fastened to a vehicle's sheet metal, thus reducing the amount of required fasteners and decreasing the overall assembly process time. Modularizing the airbag assembly also allows for the combination of typical component parts into one carrier mechanism, e.g., inflator brackets, deployment ramps, HIC brackets, grab handles, etc.

### SUMMARY

According to one embodiment of the present invention, an airbag assembly for a vehicle may comprise an airbag and a carrier mechanism. The airbag may comprise an inflatable cushion for protecting a vehicle occupant. The carrier mechanism may be attached to the airbag for fastening the airbag to the vehicle, and may comprise a body and at least two fastening mechanisms integrally formed on the body. The body may be elongated and run along a longitudinal direction of the airbag. The at least two fastening mechanisms may be configured to mate with complementary mechanisms on the vehicle.

According to another embodiment of the present invention, an airbag assembly for a vehicle may comprise an airbag comprising an inflatable cushion for protecting a vehicle occupant; and a carrier mechanism attached to the airbag for fastening the airbag to the vehicle. The carrier mechanism may comprise at least one grab bar extending along a longitudinal length of the airbag for installing the airbag assembly into the vehicle.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a schematic view of a vehicle illustrating a side curtain airbag following deployment according to an embodiment of the present invention.

FIG. 2A is a perspective view of the airbag assembly attached to vehicle sheet metal according to an embodiment of present invention.

FIG. 2B is a front view of the airbag assembly of FIG. 2A attached to vehicle sheet metal in which the airbag is not shown.

FIG. 2C is a front view of the carrier mechanism of FIG. 2B.

FIG. 2D is a rear view of the carrier mechanism of FIG. 2B.

FIG. 3 is a schematic view of the fastening locations of the carrier mechanism according to an embodiment of the present invention.

FIGS. 4A and B are front and side schematic views of a carrier mechanism with hinges according to an embodiment of the present invention.

FIG. 5 is a frontal view of an airbag assembly with a channel carrier mechanism attached to vehicle sheet metal according to another embodiment of the present invention.

FIG. 6 is a side schematic view of an airbag cushion folded within a channel carrier mechanism according to an embodiment of the present invention.

FIG. 7 is a side schematic view of an airbag cushion folded within a channel carrier mechanism according to another embodiment of the present invention.

FIG. 8 is a perspective internal view of a channel carrier mechanism according to an embodiment of the present invention.

FIG. 9 is a partial rear view of a channel carrier mechanism with airbag according to another embodiment of the present invention.

FIG. 10 is an exploded view of an airbag assembly according to another embodiment of the present invention.

FIGS. 11A and 11B are top and front views, respectively, of an airbag assembly according to another embodiment of the present invention.

FIGS. 12A and 12B are perspective and end views, respectively, of an airbag assembly according to another embodiment of the present invention.

FIG. 13 is a top end view of an airbag assembly according to another embodiment of the present invention.

### DETAILED DESCRIPTION

An airbag is provided in vehicles for the protection of occupants in the event of a vehicle crash. It is desirable for the various components that comprise an airbag assembly to be modularized in order to reduce the overall assembly process time.

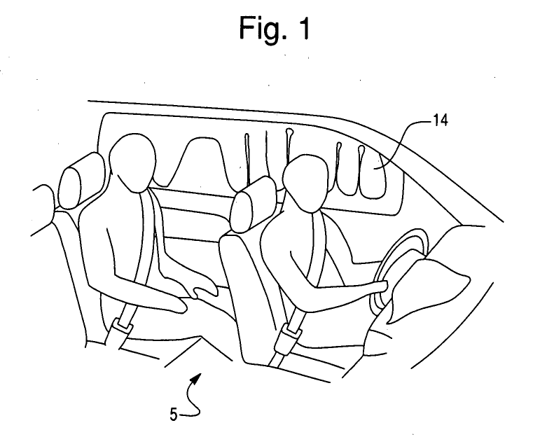

Referring to FIG. 1, the interior of a vehicle 5 is shown, according to an embodiment of present invention. A side curtain airbag cushion 14 is shown in an inflated state following deployment. Cushion 14 may be positioned on the interior of the vehicle 5, between the vehicle's side windows and the occupants of the vehicle.

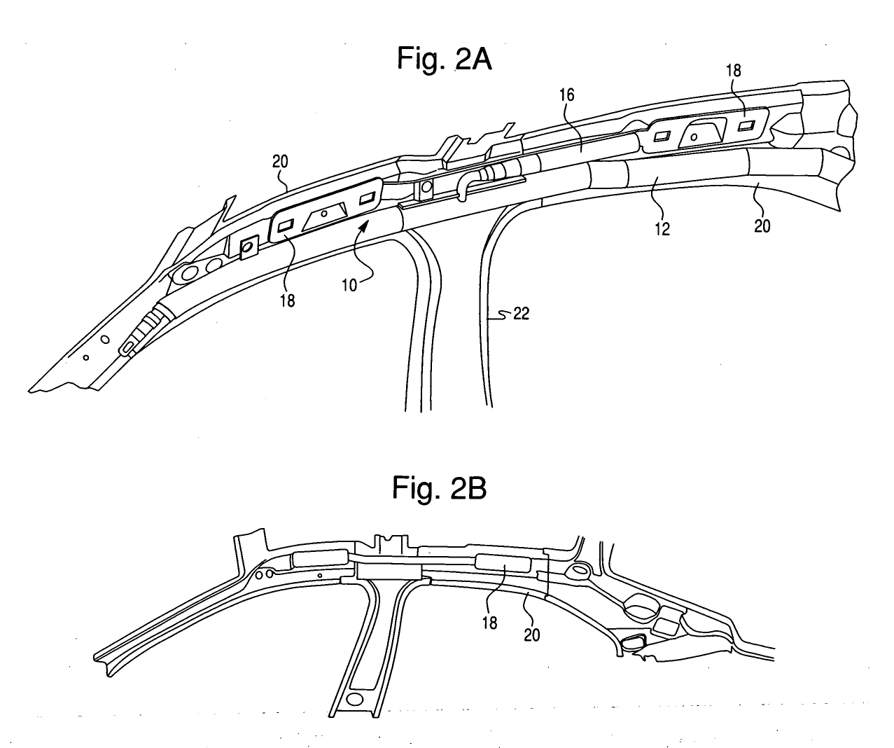

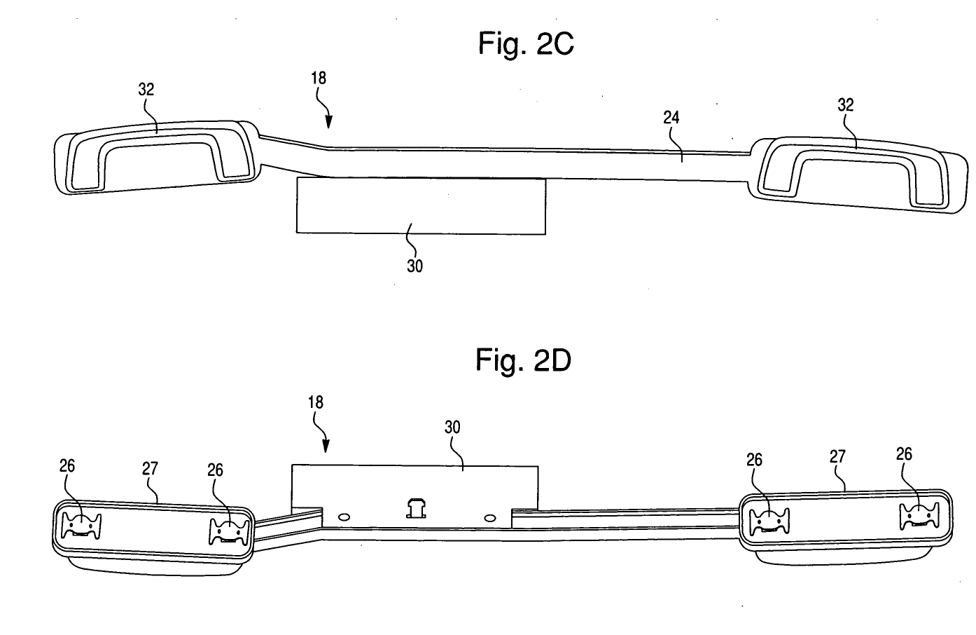

Referring to FIG. 2A, an airbag assembly 10 is shown according to an embodiment of the present invention. The airbag assembly 10 may be comprised of an airbag 12 which includes an inflatable cushion 14 (shown in FIG. 1) for protecting vehicle occupants in the event of a vehicle crash, an inflator 16 for inflating the airbag cushion 14 during deployment, and a carrier mechanism 18 attached to the airbag 12 for fastening the airbag 12 to the vehicle 5. The airbag assembly 10 can be located along the roof rail sheet metal 20 proximate to the B-pillar 22 of the vehicle 5. In FIG. 2B, a carrier mechanism 18 without the airbag is shown mounted to the roof rail sheet metal 20.

Referring to FIGS. 2C and 2D, the carrier mechanism 18 is shown according to an embodiment of the present invention. The carrier mechanism 18 may include a body 24 and fastening mechanisms 27 configured to mate with complementary mechanisms positioned on the roof rail sheet metal 20 of the vehicle 5. The body 24 is elongated and is positioned in a generally longitudinal direction of the airbag 12. Grab handles 32 are positioned on the carrier mechanism 18 for the installation of the airbag assembly 10 into the vehicle. The grab handles 32 may be attached to the fastening mechanisms 27 by using snap fasteners 26 located at the handles 32 and are inserted into apertures on fastening mechanism 27. In an alternative embodiment, the snap fasteners may be attached to the fastening mechanisms 27 which are fed through apertures located in the grab handles 32.

As shown in FIG. 2C, the airbag assembly 10 includes a ramp assembly 30 for preventing the airbag 12 from being caught on the vehicle's interior trim during the deployment of the airbag. The ramp assembly may be situated at any suitable location along the body 24 of the carrier mechanism 18. According to one embodiment, multiple ramp assemblies may be attached to the body 24 of the carrier mechanism. The ramp assembly 30 may be attached to the body 24 in any suitable fashion. For example, bolts may be fed through overlapping apertures on the ramp assembly 30 and the body 24, and secured by one or more nuts. Alternatively, rivets can be used to attached the ramp assembly to the body 24.

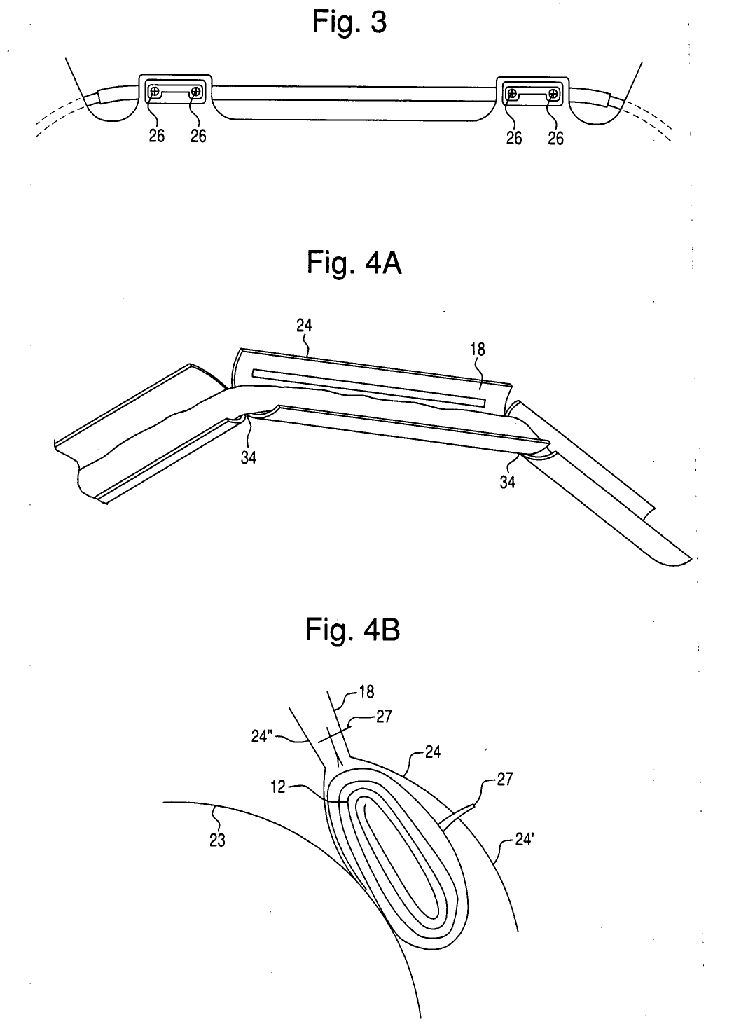

Referring to FIG. 3, the locations of the fastening mechanisms 27 of the carrier mechanism 18 are shown according to an embodiment of the invention. The fastening mechanisms may be located at any suitable points along the body 24 of the carrier mechanism 18. Also, any suitable number of fastening mechanism may be used, such as one, two, three, four, or more.

The fastening mechanisms 27 shown in FIGS. 2A through 2D show, for example, two rectangular shaped inserts with ridges located at the periphery of the rectangular shape. These inserts are placed inside corresponding apertures of slightly bigger size and similar shape so as to attached the carrier mechanism to the roof rail sheet metal 20 of the vehicle 5. Other shapes besides rectangular can be used such as circular, oval, triangular, trapezoidal, or the like. According to one embodiment, the periphery of the rectangular shaped inserts can be a tight fit into the corresponding apertures in the roof rail sheet metal so as to maintain the airbag assembly in its fixed location in the vehicle. According to alternative embodiment, the snap fasteners 26 attaching the handles 32 may be longer than the thickness of the rectangular inserts so that the snap fasteners extend into corresponding apertures in the roof rail sheet metal so as to hold the airbag assembly in its fixed location in the vehicle.

In FIGS. 4A and 4B, a carrier mechanism 18 containing a body 24 with hinges 34 is shown according to an embodiment of present invention, which may permit compact storage and/or transport of the airbag assembly before installation into the vehicle 5. In this case, the carrier mechanism comprises a body 24 that includes a back portion 24′ and a front portion 24″. The back portion 24′ may be any suitable shape, for example, a substantially C-shaped cross-section, as seen in FIG. 4A. The back portion 24′ may also include apertures for fastening members 27 to be fed through so as to attach the airbag assembly to the body structure of the vehicle. The front portion 24″ may be clamped or bolted to the back portion 24′ to maintain the airbag in its folded or rolled up position. A headliner 23 may conceal the airbag assembly as it is attached to the roof rail sheet metal so as to present a more presentable appearance for the interior of the vehicle. With such a configuration, the airbag 12 may be folded or rolled up between the body and headliner for a compact structure for installation.

With the carrier mechanism 18 from which the curtain airbag 12 is hung, the airbag assembly 10 may be modularized. For example, the carrier mechanism 18 can be a supporting member which can be fastened into the target vehicle's roof rail sheet metal 20. One possible benefit of such a mechanical device is a reduction in the amount of required fastening mechanisms 27 to the vehicle's roof rail sheet metal 20, which can reduce the original equipment manufacturer's (OEM) overall assembly process time. Additionally, the carrier mechanism 18 has the ability to modularize the curtain airbag assembly 10 through the combination of typical component parts into one carrier mechanism, including, but not limited to: inflator brackets, deployment ramps, HIC brackets, grab handles, etc.

According to one embodiment of the present invention, the carrier mechanism 18 may act as an assembly aid for constructing the curtain airbag assembly within the curtain airbag manufacturer's assembly plant(s). Furthermore, according to an embodiment of the present invention, the carrier mechanism can be installed in a vehicle with or without integral grab handles 32.

The carrier mechanism may also be an intermediary between the airbag 12 and sheet metal 20 of a vehicle. For example, the airbag assembly 10 is positioned underneath a headliner surface and behind a trim portion at the B-pillar 22. The airbag assembly 10 may also include a ramp assembly 30 as one possible mechanism to prevent the airbag 12 from being caught on the interior trim during deployment. Also, the carrier mechanism 18 may be more rigid than the ramp assembly 30. Of course, any other suitable mechanism other than the ramp assembly may be utilized for this function as well.

The airbag 12 is attached to the carrier mechanism 18 by any suitable fastening or sliding mechanism, for example tearable straps, belts, adhesive strips, clamps, or the like. The carrier mechanism 18 is attached to the vehicle by any suitable type of fastening or sliding mechanism, for example pins, rivets, bolts, or the like. The inflator 36 for the airbag assembly 10 is attached to the carrier by any suitable mechanism. For example, a cylinder body may be attached to the body 24 of the carrier mechanism which can mate against the inflator body in a press fit manner.

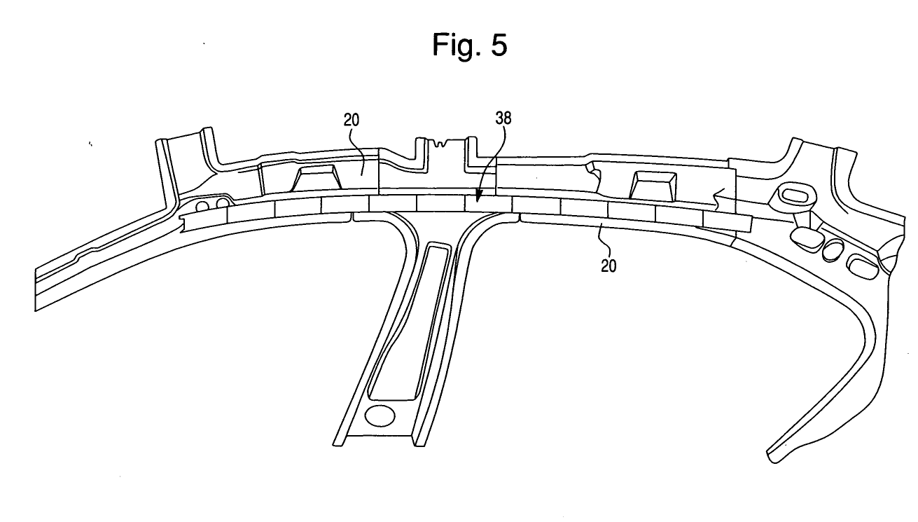

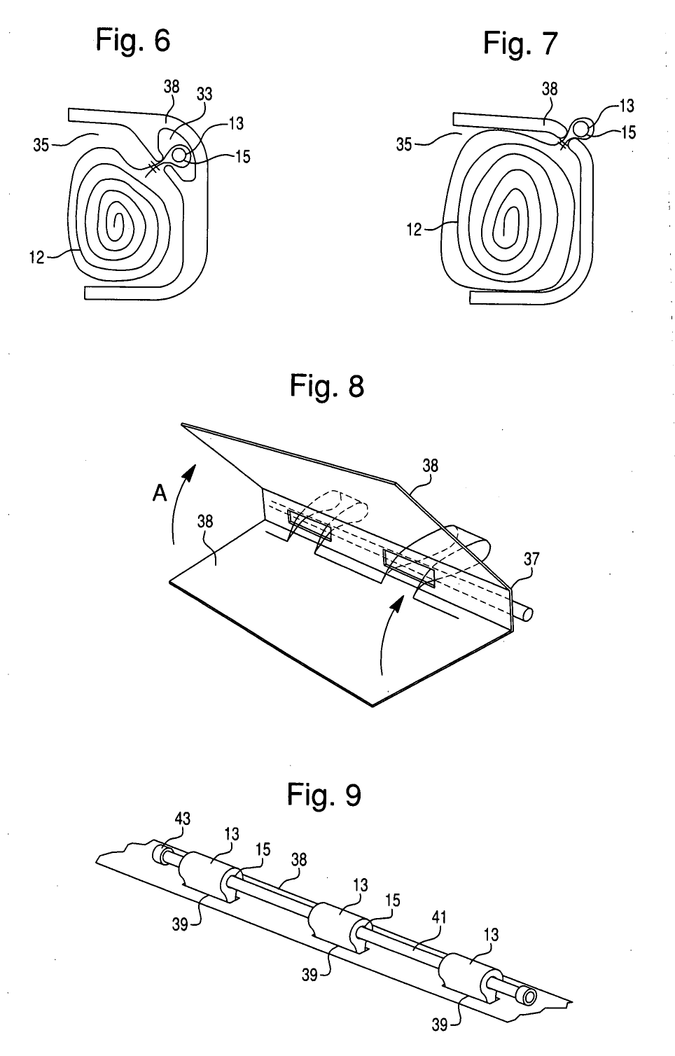

Referring to FIGS. 5 and 6, a carrier mechanism 18 may comprise a channel carrier mechanism 38 according to an embodiment of the present invention. The channel carrier mechanism 38 may be a plastic or metal enclosure that covers around a substantial portion of the airbag. The channel carrier mechanism 38 may comprise any other suitable material or a combination of multiple materials.

As seen in FIG. 6, the folded or rolled up airbag 12 fits inside a channel 35 and tabs 13 of the airbag are fed into a smaller internal channel 33 via one or more slits between the channel 35 and the channel 33. The tabs 13 of the airbag have apertures 15 in which a rod, cylinder or similar mechanism is inserted so as to fix the airbag to the carrier mechanism 38 by making the cross section of the tabs 13 larger than the width of the slits leading to the internal chamber 33. Accordingly to another embodiment, a single continuous tab 13 extending substantially along the length of the airbag may be used instead of a plurality of tabs.

FIG. 7 shows an alternative embodiment of the channel carrier mechanism in which the plurality of tabs are fed through slits so as to extend outside the carrier mechanism 38, as opposed to fitting inside an internal channel. As in the embodiment shown in FIG. 6, a rod, cylinder, or the like may be inserted through all the apertures 15 in the tabs 13 so as to prevent the tabs from sliding through the slit leading to the channel 35; thus fixing the airbag 12 to the carrier mechanism.

The channel carrier mechanism 38 of FIGS. 6 and 7 may cover the entire or a majority of the length of the airbag body when the airbag is installed in the vehicle. The channel carrier mechanism 38 can protect the airbag from weld burrs or rough or sharp spots in the sheet metal of the vehicle. The channel mechanism 38 attaches to the vehicle at various portions along its length (either the entirety of its length at various locations, or just portions of its length). The body of the airbag 12 attaches to the channel mechanism 38, which then attaches to the vehicle's roof rail sheet metal 20. The channel mechanism 38 initially surrounds or substantially surrounds the body of airbag 12. During inflation, the channel mechanism 38 may be capable of bending or flexing to open up (for example, to form a C or U-like shape) to allow the inflating body of the airbag 12 to fully deploy. FIG. 8 depicts the opening of the C-shape at bendable corners 37 in the direction of arrow A. FIG. 9 shows how the tabs 13 extend through the slits 39 of the carrier mechanism 38 and how the rod 41 extends through the apertures 15 of the tabs 13. Fittings 43 can also be attached to the ends of the rod 41 to prevent the tabs 13 from sliding off the rod 41.

With the channel mechanism 38 of the carrier mechanism, the curtain airbag 12 may be hung in the vehicle. The channel mechanism 38 is then the supporting member which is fastened to the vehicle's sheet metal 20 at one or more locations along the carrier mechanism. The channel mechanism 38 may reduce the number of required fastening mechanisms for the airbag 12 to be attached to the vehicle's sheet metal 20, which can reduce overall assembly time for the OEM. Also, the channel carrier mechanism 38 may include a cover material to prevent contamination of the airbag device prior to deployment. Furthermore, the airbag assembly (which may be, for example, a curtain or “head side” airbag) is modularized through the combination of typical component parts into one carrier mechanism, including, but not limited to: inflator brackets, deployment ramps, HIC brackets, vehicle attachment points, etc.

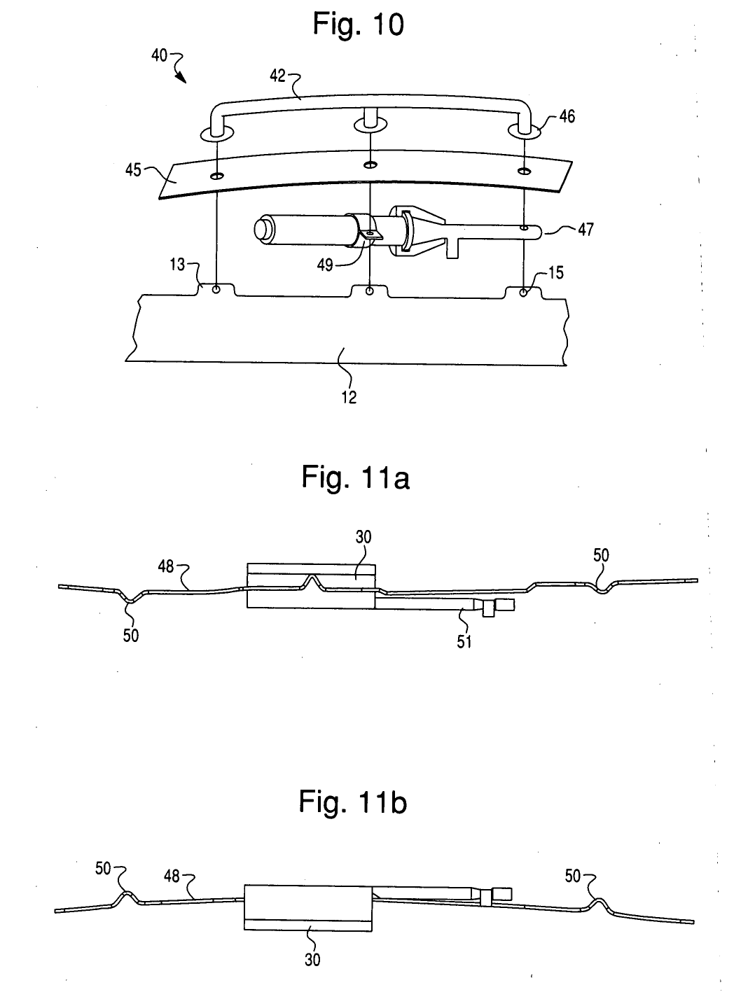

FIG. 10 illustrates another embodiment of the present invention. In this embodiment, the airbag assembly includes a grab handle assembly 40. A portion of the head-side airbag assembly may then be modularized. Separate elements of the system may be combined to provide a “center module section.” Front and rear lengths of the cushion may then be folded over the center portion for ease of shipping and handling. In this embodiment, a single or a plurality of connected grab bars 42 (such as for example two, three, four, or more grab bars) are used as the “backbone” or core for the modular center section of the assembly. The backbone can be rigid or semi-rigid. The backbone comprising the grab bar 42 provides an ergonomic mechanism to handle and install the center portion of the airbag module in an OEM plant.

The grab bar 42 (or modular backbone) may serve as an assembly fixture (within the supplier plant) to which additional parts of the airbag system can be attached. In addition, the grab bar 42 may provide the following advantages: easier handling (assembly aid) in the supplier and OEM plants; easier, more ergonomic assembly of the airbag into the vehicle; reduced cycle time to install the airbag module into the vehicle; and, among other things, integration of independent functions into a common system (a modular system). Furthermore, the grab bar 42 of the carrier mechanism may also serve as a grab bar for a vehicle occupant after installation. For such an embodiment, at least a portion of the grab bar/carrier mechanism is visible or accessible to the vehicle occupant.

As seen in FIG. 10, the grab bar assembly 40 can mount to the vehicle near (or directly to) the trim panel 45 (such as an A-pillar, roof-liner, or the like). The assembly can include trim or headliner bezel inserts 46. The bezel inserts 46 (“garnish”) can cover holes in the trim through which fasteners are inserted. The trim and/or the bezel inserts 46 can comprise headliner material, plastic, or any other suitable material. The airbag 12 can be attached by snap connectors, threaded fasteners, or any other mechanism. The attachment mechanism can be, for example, one per attachment point. The fasteners are fed through apertures 15 of the tabs 13 of the airbag, the holes in the trim panel 45, and into holes in the bezel inserts 46 of the grab bars 42. Also, an inflator 47 may also be attached such that the inflator 47 is attached between the trim 45 and the airbag 12. One or more brackets, such as a C-clamp 49, is used to fasten the inflator 47. An aperture in the bracket aligns with the apertures 15 of the airbag, the apertures of the trim, and the holes in the grab bars 42.

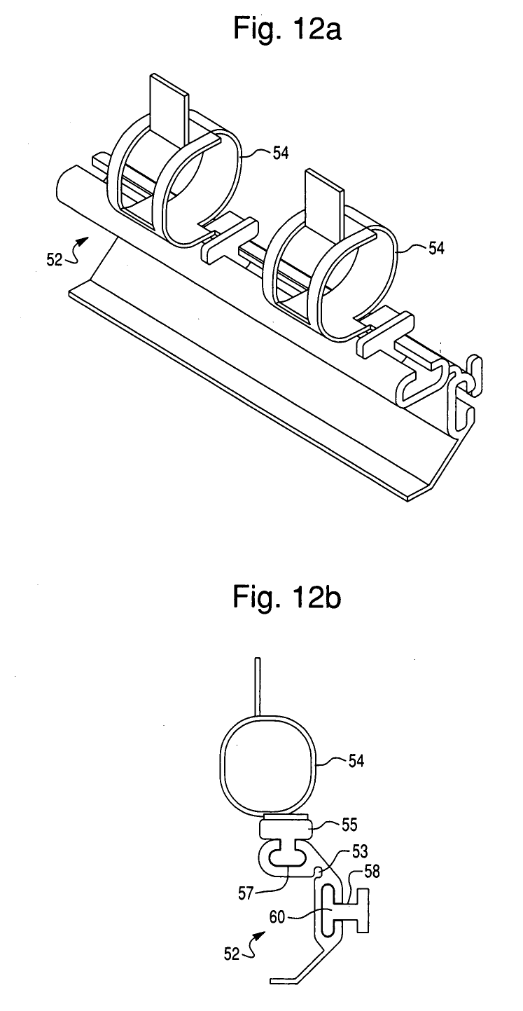

Another embodiment of the present invention is illustrated in FIGS. 11A and 11B. In this embodiment, an elongated carrier mechanism 48 may be a bendable rod, which includes snap fittings 50 for attaching the carrier mechanism 48 to the vehicle. The snap fittings 50 are bent sections that are inserted into complementary fittings such as clips in the roof rail sheet metal. A deployment ramp assembly 30 could be added. The ramp may be integral to the carrier mechanism 48, be attached to one of the snap fittings 50, or be attached by straps or other types of fasteners. The deployment ramp assembly 30 may also include a clamp section 51 into which the inflator of the airbag assembly snaps into so that the inflator is also attached to the carrier mechanism 48. The airbag can be attached to the carrier mechanism 48 of FIGS. 11A and 11B through the use of tearable straps, bands, adhesive strips or the like along the length of the carrier mechanism.

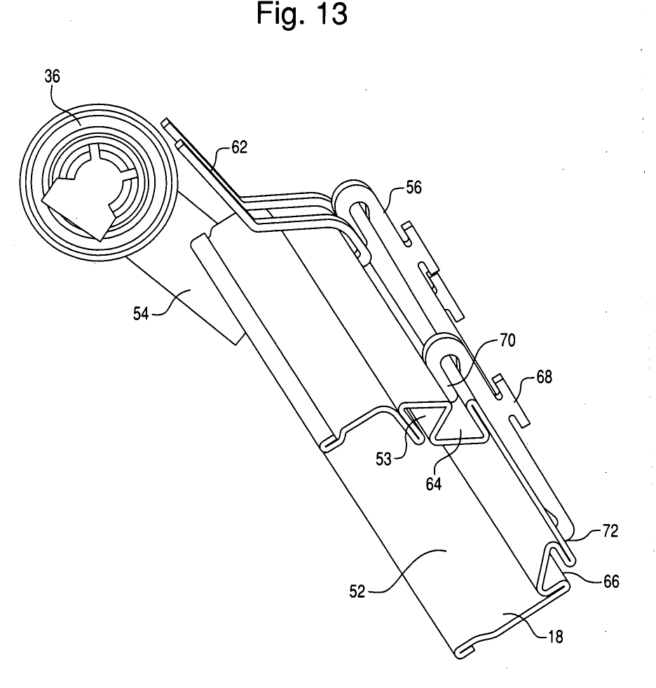

FIGS. 12A and 12B show another embodiment of the present invention. In this embodiment, the carrier mechanism includes a channel 52 formed in a reverse C-like shape that houses a folded airbag (not shown). The airbag is attached to the carrier mechanism in a manner similar to the embodiment shown in FIG. 6 in which tabs of the airbag with apertures are fed through slits and enter into an internal channel 53. A rod, cylinder, or the like is fed through the apertures of the tabs so as to prevent the airbag from detaching from the carrier mechanism during deployment. An inflator is attached to the carrier mechanism by one or more circular mounting bracket 54. These brackets have I-shaped fittings 55 that fit into corresponding slots 57 on the top side of the carrier mechanism. One side of the fitting 55 is attached (by adhesive, brazing, welding, integrally molded, etc.) to the mounting bracket 54 while the other side attaches by a sliding fit into the slot 57 of the carrier mechanism. Another set of I-shaped fittings 58 fits into a corresponding slot 60 on the side of the carrier mechanism. One side of the fitting 58 is attached by a sliding fit to the carrier mechanism in slot 60 while the other side fits into one or more corresponding slots (similar to the slots 60) on the side of the vehicle frame. Other fasteners can be used besides the I-shaped fasteners, if desired.

FIG. 13 shows another embodiment of the present invention in which the carrier mechanism 18 includes a channel 52 formed in a reverse C-like shape that houses a folded airbag (not shown). The airbag is attached in a manner similar to the embodiment shown in FIG. 6 in which tabs with apertures are fed through slits into internal channel 53. A rod, cylinder, or the like is fed through the apertures of the tabs so as to prevent the airbag from detaching from the carrier mechanism during deployment. The inflator 36 is attached to the carrier mechanism by using a mounting bracket 62 which slides into the channel 64 of the carrier mechanism 18. Also, a set of fittings 56 for mounting the carrier mechanism to the vehicle frame has two protrusions 70 and 72 that fit into corresponding slots 64 and 66, respectively, on the side of the carrier mechanism. The protrusions 70 and 72 slide into the slots 64 and 66 so as to attached the fittings 56 to the carrier mechanism. Each fitting 56 also has a T-shaped fitting 68 which slides into a corresponding slot in the side of the vehicle frame. Of course, other fasteners can be used besides the T-shaped fitting, if desired.

With the use of the disclosed and other embodiments of the present invention, one or more of the following advantages may be provided: a rigid curtain airbag assembly; decreased packaging for shipping to OEM assembly plants (compared to full-length diffuser designs); ergonomic assembly for the vehicle installer; reduced number of fasteners to attach to the sheet metal of the OEM vehicle; a quicker installation of the airbag assembly; modularization of component parts into one carrier mechanism; the reduction of the total number of parts; and, among other things, distribution of airbag inflation deployment reaction forces through the mechanical carrier mechanism.

These and other features, aspects, and advantages of the present invention will become apparent from the following description, appended claims, and the accompanying exemplary embodiments shown in the drawings, which are briefly described below.

It is important to note that the construction and arrangement of the modular curtain airbag assembly as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the description. For example, elements shown as integrally formed may be constructed of multiple parts or elements, the position of the elements may be reversed or otherwise varied, and the nature or number of discrete elements or positions may be altered or varied. Other substitutions, modifications, changes and omissions may be made in the design, operating conditions and arrangement of the exemplary embodiments.

What is claimed is:

1. An airbag assembly for a vehicle, comprising:
an airbag comprising an inflatable cushion for protecting a vehicle occupant; and
a carrier mechanism attached to the airbag for fastening the airbag to the vehicle,
wherein the carrier mechanism comprises a body and at least two fastening mechanisms integrally formed on the body,
wherein the body is elongated and runs along a longitudinal direction of the airbag, and
wherein the at least two fastening mechanisms are configured to mate with complementary mechanisms on the vehicle.

2. The airbag assembly according to claim 1, further comprising a ramp assembly for preventing the airbag from being caught on the vehicle's interior trim during deployment of the airbag.

3. The airbag assembly according to claim 2, wherein the carrier mechanism is more rigid relative to the ramp assembly.

4. The airbag assembly according to claim 1, wherein the carrier mechanism is configured to be installed between the airbag and a wall of the vehicle

5. The airbag assembly according to claim 1, wherein the carrier mechanism comprises at least one integral grab handle for installation of the airbag assembly in the vehicle.

6. The airbag assembly according to claim 1, wherein the carrier mechanism further comprises at least one grab handle attached to at least one fastening mechanism by at least one snap fitting.

7. The airbag assembly according to claim 1, wherein the body of the carrier mechanism is substantially C-shaped.

8. The airbag assembly according to claim 1, wherein the airbag further comprises an inflator and is attached to the carrier mechanism.

9. The airbag assembly according to claim 1, wherein the at least two fastening mechanisms are configured to snap or slide into the receiving mechanisms on the vehicle.

10. The airbag assembly according to claim 1, wherein the body of the carrier mechanism is an enclosure that covers a substantial portion of the airbag in a circumferential direction when the airbag is folded or rolled up for installation into the vehicle.

11. The airbag assembly according to claim 10, wherein the enclosure covers a majority of the airbag's length.

12. The airbag assembly according to claim 10, wherein the at least two fastening mechanisms comprise fastening mechanisms located as various positions along the enclosure's length.

13. The airbag assembly according to claim 10, wherein the enclosure is C or U-shaped and configured to open when the airbag is deployed.

14. An airbag assembly for a vehicle, comprising:
an airbag comprising an inflatable cushion for protecting a vehicle occupant; and
a carrier mechanism attached to the airbag for fastening the airbag to the vehicle,
wherein the carrier mechanism comprises at least one grab bar extending along a longitudinal length of the airbag for installing the airbag assembly into the vehicle.

15. The airbag assembly according to claim 14, wherein the at least one grab bar comprises a plurality of connected grab bars.

16. The airbag assembly according to claim 14, wherein the at least one grab bar is configured for attaching additional parts of the airbag assembly.

17. The airbag assembly according to claim 14, wherein the grab bar is configured to serve as a grab bar for a vehicle occupant by being at least partially visible to the vehicle occupant when installed in the vehicle.

18. The airbag assembly according to claim 17, further comprising an A-pillar trim, wherein the grab bar is configured to mount directly to the A-pillar trim.

19. The airbag assembly according to claim 17, further comprising headliner bezel inserts for covering holes in an A-pillar trim of the vehicle.
